(19) United States
(12) Patent Application Publication
(10) Pub. No.: US 2016/0183192 A1
(43) Pub. Date: Jun. 23, 2016

(54) MOBILITY AND CHANNEL CONDITION BASED POWER CONSERVATION

(71) Applicant: QUALCOMM Incorporated, San Diego, CA (US)

(72) Inventors: Insung KANG, San Diego, CA (US); Ping ZHOU, San Diego, CA (US); Chao JIN, San Diego, CA (US); Thawatt GOPAL, San Diego, CA (US); Shanshan WANG, San Diego, CA (US); Disha AHUJA, San Jose, CA (US); Rashmi KULKARNI, Menlo Park, CA (US); Josephine BOLOTSKI, Seattle, WA (US); Justin MCGLOIN, Los Altos, CA (US); Carlos PUIG, Santa Clara, CA (US)

(21) Appl. No.: 14/690,275

(22) Filed: Apr. 17, 2015

Related U.S. Application Data
(60) Provisional application No. 62/095,672, filed on Dec. 22, 2014.

(51) Int. Cl. H04W 52/02; H04M 1/725

(52) U.S. Cl. CPC H04W 52/0254; H04M 1/72577

(57) ABSTRACT

A user equipment (UE) controls power consumption of the UE based on mobility information and channel conditions experienced by the UE. In one instance, the UE determines its level of mobility based on a Doppler frequency spread of received communications. The UE disables a motion sensor when the level of mobility is above a first threshold. The UE then controls the communications based on the motion sensor and channel conditions experienced by the UE when the level of mobility is below the first threshold.

### CROSS REFERENCE TO RELATED APPLICATION

This application claims the benefit of U.S. provisional patent application No. 62/095,672, filed on Dec. 22, 2014, in the names of KANG et al., the disclosure of which is expressly incorporated by reference herein in its entirety.

### BACKGROUND

1. Field

Aspects of the present disclosure relate generally to wireless communication systems, and more particularly, to power conservation based on a level of mobility of a user equipment, a mobility state of the user equipment and channel conditions experienced by the user equipment.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA), and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method of controlling power consumption of a user equipment (UE) includes determining a level of mobility of a user equipment (UE) based on a Doppler frequency spread of received communications. The method also includes disabling a motion sensor when the level of mobility is above a first threshold. The method also includes controlling communications of the UE based on the motion sensor and channel conditions experienced by the UE when the level of mobility is below the first threshold.

According to another aspect of the present disclosure, an apparatus for controlling power consumption includes means for determining a level of mobility of a user equipment (UE) based on a Doppler frequency spread of received communications. The apparatus may also include means for disabling a motion sensor when the level of mobility is above a first threshold. The apparatus may also include means for controlling communications of the UE based on the motion sensor and channel conditions experienced by the UE when the level of mobility is below the first threshold.

Another aspect discloses an apparatus for controlling power consumption includes a memory and one or more processors coupled to the memory. The processor(s) is configured to determine a level of mobility of a user equipment (UE) based on a Doppler frequency spread of received communications. The processor(s) is also configured to disable a motion sensor when the level of mobility is above a first threshold. The processor(s) is also configured to control communications of the UE based on the motion sensor and channel conditions experienced by the UE when the level of mobility is below the first threshold.

Yet another aspect discloses a computer program product for controlling power consumption having a non-transitory computer-readable medium. The computer-readable medium has non-transitory program code recorded thereon which, when executed by the processor(s), causes the processor(s) to determine a level of mobility of a user equipment (UE) based on a Doppler frequency spread of received communications. The program code also causes the processor(s) to disable a motion sensor when the level of mobility is above a first threshold. The program code also causes the processor(s) to determine whether to wait for a system information block from the strongest frequency based on a metric. The program code further causes the processor(s) to control communications of the UE based on the motion sensor and channel conditions experienced by the UE when the level of mobility is below the first threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a user equipment (UE) in a telecommunications system.

FIG. 4 illustrates a state diagram of user equipment states classified into different categories according to aspects of the present disclosure.

FIG. 5 illustrates a mobility and channel condition based power conservation implementation according to aspects of the disclosure.

FIG. 6 is a flow diagram illustrating a method for wireless communication according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

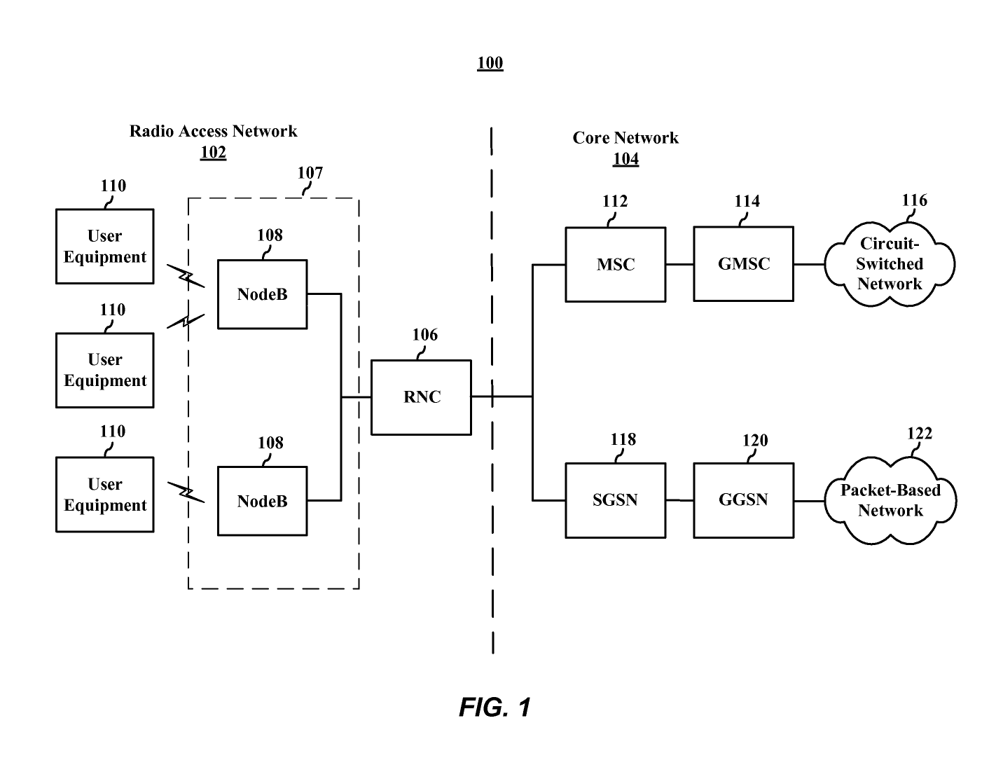

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring, and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General packet radio service (GPRS) is designed to provide packet-data services at speeds higher than those available with standard GSM circuit switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

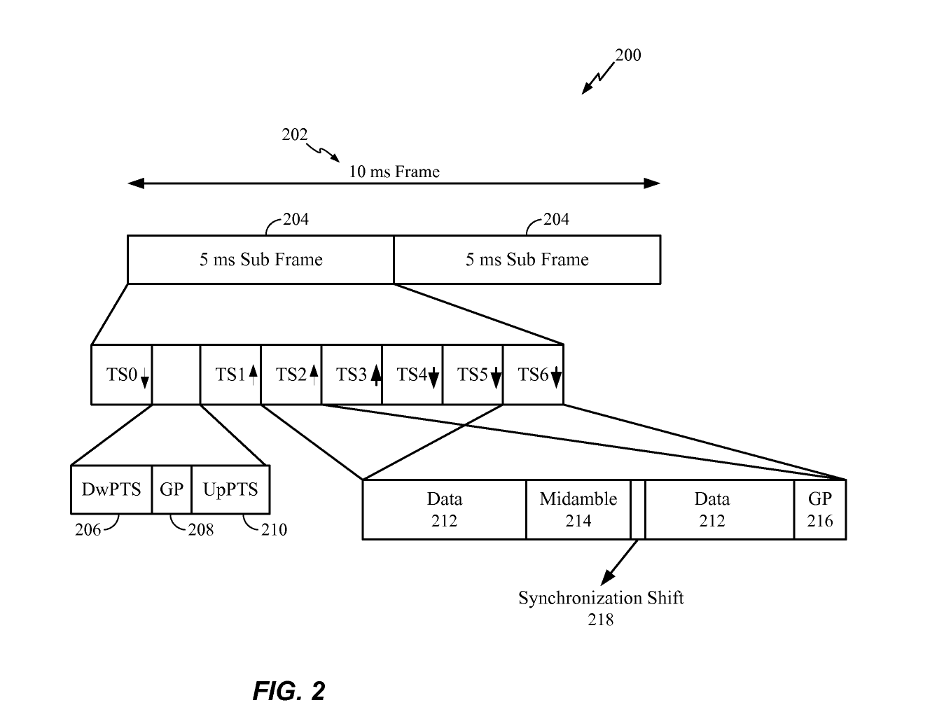

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

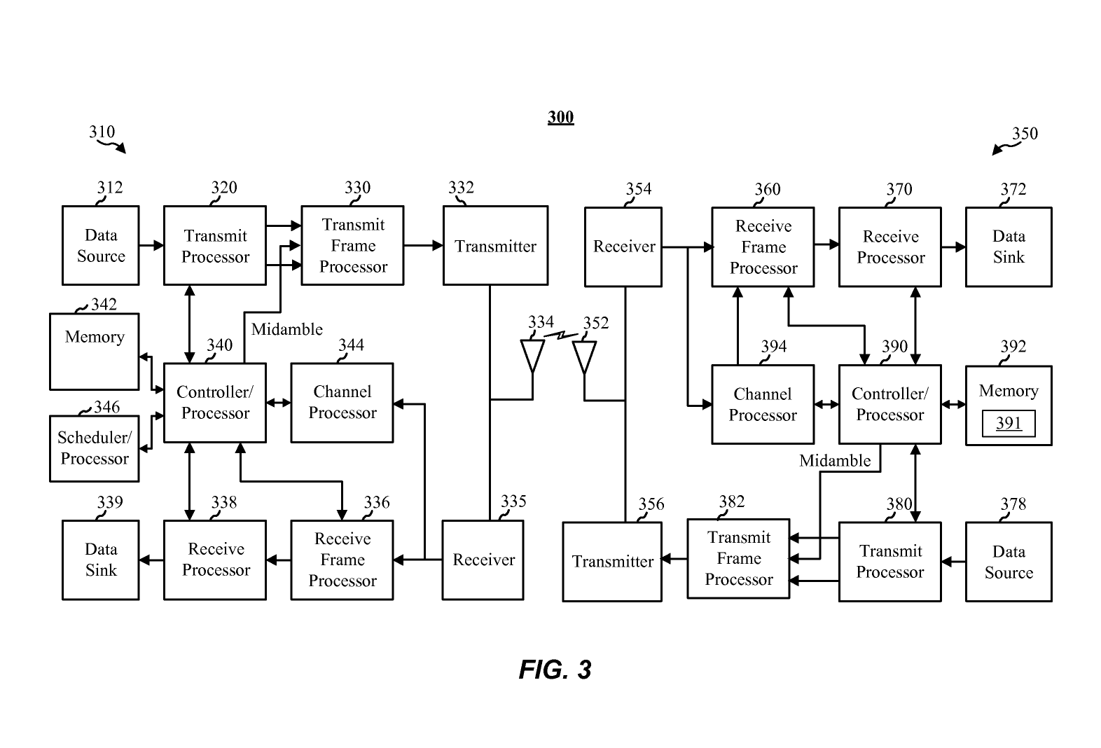

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a power control module 391 which, when executed by the controller/processor 390, configures the UE 350 for power reduction according to aspects of the present disclosure. A scheduler/processor 346 at the node B 310 may allocate resources to the UEs and schedule downlink and/or uplink transmissions for the UEs.

A user equipment (UE) may be a multi subscriber identity module (SIM) device or a single SIM device and may occasionally perform measurements of neighbor cells of one or more RATs to facilitate the handover or reselection. For example, the UE may be a dual SIM-dual active (DSDA) device, which means each of the SIMs of the UE can connect to a network simultaneously. The UE may also be a dual SIM-dual standby (DSDS) device, which means the UE is limited to connecting to one network at a time. For example, the UE is in an active state when the UE is connected to a network for a voice or data call. The UE, however, is in a standby state when the UE is not connected to the network for a voice or data call.

Power consumption during a standby/active state of the multi SIM or single SIM device, however, may be inefficient. In some specifications, standby power tests are designated for UEs operating in different radio access technologies (e.g., TD-SCDMA). Some UEs, however, fail to meet these specifications and are therefore undesirable for use in a network operating according to these standards.

The power consumption inefficiency may be increased when the UE is at a cell edge, that is when the UE is close to or at an intersection of two cellular regions. In this case, the UE is subject to a ping-pong effect where the UE is bounced between the two cells causing an increase in power consumption.

### Mobility and Channel Condition Based Power Conservation

Aspects of the present disclosure are directed to controlling power consumption of a user equipment (UE) or mobile device based on mobility information and channel conditions experienced by the UE. The mobility information may include a mobility state (e.g., stationary/mobile) and/or level of mobility (e.g., low/high speed) of the UE. The power consumption may be controlled during a standby or active state of a multi subscriber identity module (SIM) or single SIM device (e.g., UE).

In one aspect of the disclosure, a motion sensor device may determine the mobility state (e.g., stationary) and a modem sensor core device may determine the level of mobility of the UE. In one configuration, the motion sensor device and the modem sensor core device of the UE are coupled to a modem device of one or more radio access technologies. A UE classification device receives indications corresponding to the mobility state and the level of mobility from the motion sensor device and the modem sensor core device, respectively. The UE classification device controls the power consumption of the UE based on the mobility information and also based on channel conditions determined by the modem device.

The channel conditions may include a load on a channel (e.g., the percentage of time the channel is being used), measured signal power (e.g., received signal strength indicator (RSSI)), channel quality, channel noise, traffic types, user types, received signal code power (RSCP), and/or received signal code power degrading degree, which is measured in decibels (dBs). The channel conditions can also be indicated by signal to interference ratio (SIR). For example, the receiver of the UE may determine the quality of the communication link based on whether the signal to interference ratio meets a threshold.

The channel condition can further be based on fading characteristics. The fading characteristics may be characterized by a channel scattering function. One aspect of channel scattering is a Doppler spread, which contains information about the level of mobility (e.g., low/high speed) of the UE. For example, a motion detection algorithm for modem protocol motion detection may be implemented in the modem sensor core device to detect the level of mobility. In one aspect of the disclosure, the detection of the level of mobility may be based on a Doppler implementation, such as a Doppler estimation. For example, the level of mobility may be based on a Doppler frequency determined based on data symbols, pilot symbols, or any combination of appropriate symbols received by the UE.

Determining the level of mobility of the UE based on the Doppler implementation, however, may not incorporate a determination of a mobility state of the UE. For example, the Doppler implementation may not determine when the UE is in a stationary state. Thus, power conservation implementations that are based on Doppler do not account for the mobility state of the UE. Therefore, such power conservation implementations achieve inadequate power savings. To mitigate the inadequate power savings, aspects of the present disclosure incorporates a motion sensor device to determine the mobility state of the UE.

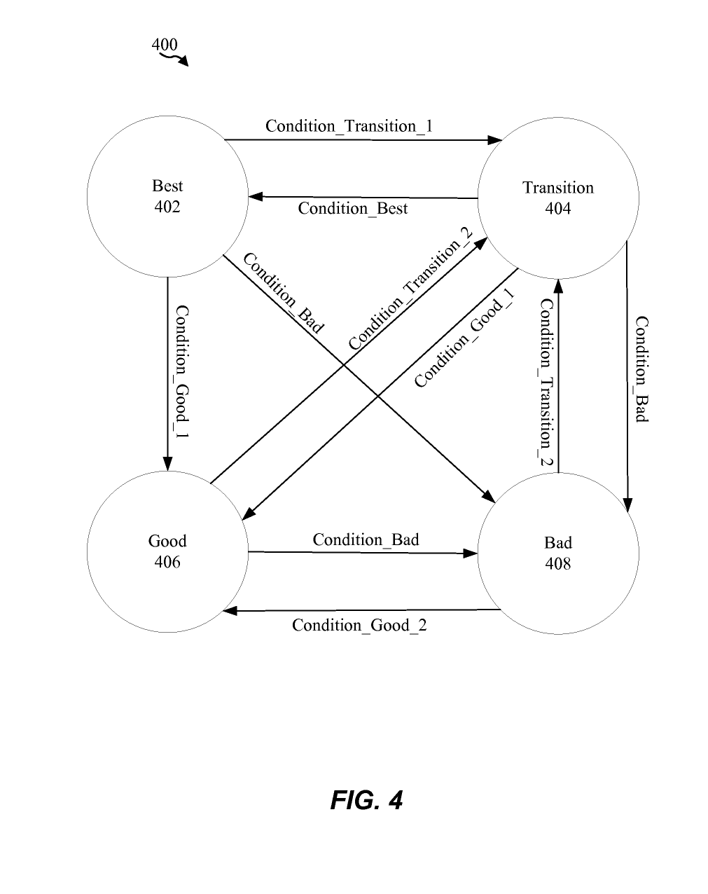

In one aspect of the disclosure, the UE incorporates the level of mobility in conjunction with the mobility state and channel conditions to control the power consumption of the UE. To achieve power savings, a user equipment state classification device indicates different classification states of the UE based on the channel conditions, the level of mobility (e.g., speed) of the UE, and the mobility state of the UE (e.g., whether the UE is stationary or mobile). For example, the UE state may be classified into different categories including “best,” “transition,” “good” and “bad,” as illustrated in the state machine diagram of FIG. 4 as well as Tables 1 and 2 (discussed below).

The sensor power consumption is high when the UE is very mobile. Thus, the motion sensor device may be enabled or disabled based on a level of mobility of the UE. For example, the motion sensor device is enabled in the best and transition classification states when the UE is below a mobility threshold, for example, when a measurement indicates the UE is in a low mobility state (e.g., low speed). The enabled sensor device can determine whether the UE is stationary. In the good and bad classification state, however, the level of mobility of the UE may exceed the mobility threshold. Under these conditions, the motion sensor device is disabled in the good and bad classification states to save power. The level of mobility (e.g., speed) of the UE may be determined based on Doppler estimation. For example, Doppler estimation may occur every discontinuous reception (DRX) cycle when the UE is in an idle state. Further, the Doppler estimation may occur in every subframe when the UE is operating in a dedicated channel state.

Table 1 illustrates exemplary classification states of the UE and corresponding parameters for each condition of the classification states. Some of the parameters indicate the level of mobility of the UE while others indicate the channel conditions. For example, the parameters that indicate the level of mobility include an indication (e.g., sensor device enabled/disabled) of the operational state of the motion sensor device and mobility information from the motion sensor device (e.g., sensor data). The parameters that indicate the channel conditions include the Doppler estimation (e.g., Doppler frequency F_{d}), channel impulse response signal to noise ratio (CIR_{SNR}), received signal code power (RSCP) and RSCP changes (e.g., RSCP drop rate). Although the Doppler frequency may indicate channel conditions, the Doppler frequency may also be used to determine the level of mobility of the UE. The CIR_{SNR} may be defined as follows:

$${CIR}_{SNR} = \frac{{Σ}_{valid shifts} shift power}{estimated\_No}$$

where No is a noise variance and Σ_{valid shifts} shift power represent the sum of all valid midamble shifts that is the same as a sum of a code channel signal power

The RSCP drop rate may be a ratio that is defined as follows:

$${Ratio}_{RSCPDrop} = \frac{RSCPn}{RSCPn - 1}$$

where n is a number of subframe measurements and RSCPn and RSCPn-1 are two continuous RSCPs of a cell serving the UE.

For example, as illustrated in Table 1, the UE is in the best classification state when the UE is in a very stable environment with desirable channel conditions. A channel condition is deemed desirable when channel parameters/metrics representing the level of mobility and the channel conditions are desirable. An example of a desirable channel parameter includes an indication from the motion sensor device that the UE is stationary, an indication that a channel to interference (CIR_{SNR}) ratio is greater than a predefined CIR_{SNR} threshold value (e.g., 10 dB) and an indication that the RSCP is greater than a predefined RSCP threshold value (e.g., −70 dBm). In the best classification state, the RSCP drop and the Doppler frequency may be irrelevant.

The UE may switch from a classification state (e.g., best classification state) to a lower classification state (e.g., transition classification state) when any one of the channel parameters for the classification state are not satisfied. For example, the UE switches to the transition classification state when the motion sensor device is enabled and indicates that the UE is mobile, and when a Doppler frequency is below a predefined frequency threshold. In some aspects, the Doppler frequency being below the predefined frequency threshold indicates that the UE is moving at a low speed. The predefined frequency threshold may be defined as a product of a constant value and a granularity of Doppler estimation (e.g., 1.5*delta_F).

TABLE 1

| | Sensor | | | | | |
|---|---|---|---|---|---|---|
| | Device | Sensor | Doppler | | | |
| | Enabled | Indication | Frequency F_{d} | CIR_{SNR} | RSCP_drop | RSCP |
| Best | Yes | Stationary | N/A | ≧10 dB | N/A | ≧−70 dBm |
| Transition | Yes | Mobile | <1.5*delta_F | ≧10 dB | N/A | ≧−70 dBm |
| Good | No | N/A | (1.5~3.5)*delta_F | 3~10 dB | N/A | (−70~−90) dBm, |
| | | | e.g., ≧1.5*delta_F | e.g., ≧3 dB | | e.g., ≧−90 dBm |
| | | | and <3.5*delta_F | and < 10 dB | | and ≦−70 dBm |
| Bad | No | N/A | ≧3.5*delta_F | <3 dB | >15 dB | <−90 dBm |

In the good classification state, the motion sensor device may be disabled to save power. In this state the mobility information from the motion sensor device is irrelevant. For example, the motion sensor device is disabled when the mobility of the UE is increased over a threshold speed value. That is, the UE is moving at a speed greater than the low speed indicated in the transition classification state. The increased speed of the UE may be determined based on the Doppler frequency.

The UE is in the good classification state when the Doppler frequency is between a predefined frequency threshold range (e.g., 1.5*delta_F˜3.5*delta_F), the CIR_{SNR} is between a predefined CIR_{SNR} threshold range (e.g., 3 dB˜10 dB) and the RSCP is between a predefined RSCP threshold range (e.g., −70 dBm˜−90 dBm). For example, the UE is in the good classification state when the Doppler frequency is greater than or equal to 1.5*delta_F and less than 3.5*delta_F, the CIR_{SNR} is greater than or equal to the predefined CIR_{SNR} threshold of 3 dB and less than 10 dB and the RSCP is greater than or equal to a predefined RSCP threshold range of −90 dBm and less than −70 dBm.

Similar to the good classification state, when the UE is in the bad classification state the motion sensor device may be disabled to save power. Accordingly, in this state the mobility information from the motion sensor device is irrelevant. The UE is in the bad classification state when the Doppler frequency is greater than or equal to another predefined frequency threshold (e.g., 3.5*delta F), the CIR_{SNR} is below another predefined CIR_{SNR} threshold (e.g., 3 dB) and the RSCP is less than another predefined RSCP threshold (e.g., −90 dBm). Although the RSCP drop is irrelevant for the best, transition and good states, the RSCP drop is one of the conditions for switching to the bad classification state from another state. For example, in the bad classification state the RSCP drop is greater than or equal to a predefined RSCP drop threshold (e.g., ≧15 dB).

FIG. 4 illustrates a state diagram 400 of user equipment states classified into different categories according to aspects of the present disclosure. For explanatory purposes, FIG. 4 is discussed with reference to Table 2. The UE switches between the classification states based on whether certain conditions are satisfied. Table 2 illustrates exemplary conditions for switching between each of the classification states.

As shown in column 1 of Table 2, a UE switches from a first classification state (e.g., best/transition/good classification state) to a lower classification state (e.g., bad classification state 408) when only one condition for the first classification state is not satisfied. However, as shown in column 2 of Table 2, the UE switches from the lower classification state to a higher classification state when all of the conditions for the higher classification state are satisfied. The conditions are satisfied when one or more sub-parameters corresponding to each condition meet a specified criteria. For example, if each sub-parameter belongs to multiple different states, the UE switches to a worse state when one or more of the sub-parameters are in the worse condition. For example, if the Doppler frequency F_{d} belongs to a set of transition Doppler frequencies (e.g., cond_transition_F_{d}), the RSCP belongs to a set of good RSCPs (cond_good_RSCP) and the CIR_{SNR} belongs to a set of bad CIR_{SNR}s (cond_bad_CIR_{SNR}), then the UE is in a bad classification state 408.

TABLE 2

| Condition_Transition_1 | Condition_Transition_2 |
|---|---|
| Motion Sensor Device: Mobile | F_{d} ∈ Cond_Transition_Fd and |
| | RSCP ∈ Cond_Transition_RSCP |
| | and CIR_{SNR} ∈ Cond_Transition_{—} |
| | CIR_{SNR} |
| Condition_Good_1 | Condition_Good_2 |
| F_{d} ∈ Good_Fd or | F_{d} ∈ Good_Fd and |
| RSCP ∈ Cond_Good_RSCP or | RSCP ∈ Cond_Good_RSCP and |
| CIR_{SNR} ∈ Cond_Good_ CIR_{SNR} | CIR_{SNR} ∈ Cond_Good_ CIR_{SNR} |
| Condition_Bad | Condition_Best |
| F_{d} ∈ cond_Bad_Fd or | Motion Sensor Device: Static for |
| RSCP ∈ Cond_Bad_RSCP or | T_{hyst} time |
| CIR_{SNR} ∈ Cond_Bad_ CIR_{SNR} or | |
| (Ratio_{RSCP} > TH_RSCP_drop | |
| and state = Good | |

In some aspects of the disclosure, the UE switches from the bad/good classification state 406 to the best classification state 402 through the transition classification state 404. For example, to switch from the bad classification state 408 to the best classification state 402, the UE first switches to the transition classification state 404, then switches from the transition classification state 404 to the best classification state 402. When the UE is in the best classification state 402, however, the UE may switch directly_to any of the other classification states (i.e., transition, good, bad). For example, to switch from the best classification state 402 to the transition classification state 404, a first transition condition (condition_transition_1) is satisfied. As shown in Table 2, the first transition condition may be satisfied when the motion sensor device indicates that the UE is mobile.

To switch from the best classification state 402 to the good classification state 406, a first good condition (condition_good_1) is satisfied. As shown in Table 2, the first good condition may be satisfied when the current Doppler frequency F_{d} belongs to a set of good Doppler frequencies (e.g., good_F_{d}), the current RSCP belongs to a set of good RSCPs or the CIR_{SNR} belongs to a set of good CIR_{SNR}s. For example, the set of good Doppler frequencies may include one or more Doppler frequencies between the predefined frequency threshold range (e.g., 1.5*delta_F˜3.5*delta_F). The set of good RSCPs may include one or more RSCPs between the predefined RSCP threshold range (e.g., −70 dBm˜−90 dBm). The set of good CIR_{SNR}s may include one or more CIR_{SNR}s between the predefined CIR_{SNR} threshold range (e.g., 3 dB˜10 dB).

To switch from the best classification state 402 to the bad classification state 408, a bad condition (condition bad) is satisfied. As shown in Table 2, the bad condition may be satisfied when the current Doppler frequency F_{d} belongs to a set of bad Doppler frequencies (e.g., cond_bad_Fd), the current RSCP belongs to a set of bad RSCPs or the CIR_{SNR} belongs to a set of bad CIR_{SNR}s. For example, the set of bad Doppler frequencies may include one or more Doppler frequencies greater than or equal to the other predefined frequency threshold (e.g., 3.5*delta_F). The set of bad RSCPs may include one or more RSCPs less than the other predefined RSCP threshold (e.g., −90 dBm). The set of bad CIR_{SNR}s may include one or more CIR_{SNR}s below the other predefined CIR_{SNR} threshold (e.g., 3 dB).

Similar to the best classification state 402, when the UE is in the transition classification state 404, the UE may switch to any of the other classification states (i.e., best, good, bad). For example, to switch from the transition classification state 404 to the best classification state 402, a best condition (condition_best) is satisfied. As shown in Table 2, the best condition may be satisfied when the motion sensor device indicates that the UE is stationary or static for a specified time (e.g., T_{hyst}). T_{hyst} may be an absolute time or a number of cycles that the state machine is running. For example, if the state machine is running during every DRX cycle in the idle state, then T_{hyst} may be defined as the number of DRXcycles (N).

Similar to switching from the best classification state 402 to the good classification state 406, to switch from the transition classification state 404 to the good classification state 406, the first good condition (condition_good_1) is satisfied. Further, similar to switching from the best classification state 402 to the bad classification state 408, to switch from the transition classification state 404 to the bad classification state 408, the bad condition (condition_bad) is satisfied.

When the UE is in the good classification state 406, the UE may switch to the transition classification state 404 or the bad classification state 408. For example, to switch from the good classification state 406 to the transition classification state 404, a second transition condition (condition_transition_2) is satisfied. As shown in Table 2, the second transition condition may be satisfied when a current Doppler frequency F_{d} belongs to a set of transition Doppler frequencies (e.g., cond_transition_Fd), a current RSCP belongs to a set of transition RSCPs (e.g., cond_transition_RSCP) and the CIR_{SNR} belongs to a set of transition CIR_{SNR}s (e.g., cond_transition_CIR_{SNR}). For example, the set of transition Doppler frequencies may include one or more Doppler frequencies less than the predefined frequency threshold (e.g., 1.5*delta_F). The set of transition RSCPs may include one or more RSCPs greater than or equal to the predefined RSCP threshold (e.g., −70 dBm). The set of transition CIR_{SNR}s may include one or more CIR_{SNR}s greater than or equal to the predefined CIR_{SNR} threshold (e.g., 10 dB).

Further, similar to switching from the best classification state 402 to the bad classification state 408, to switch from the good classification state 406 to the bad classification state 408, the bad condition (condition_bad) is satisfied.

When the UE is in the bad classification state 408, the UE may switch to the transition classification state 404 or the good classification state 406. For example, to switch from the bad classification state 408 to the good classification state 406, a second good condition (condition_good_2) is satisfied. As shown in Table 2, the second good condition may be satisfied when a current Doppler frequency F_{d} belongs to a set of good Doppler frequencies (e.g., cond_good_Fd), a current RSCP belongs to a set of good RSCPs (e.g., cond_good_RSCP) and the CIR_{SNR} belongs to a set of good CIR_{SNR}s (e.g., cond_good_CIR_{SNR}). For example, the set of transition Doppler frequencies may include one or more Doppler frequencies between the predefined frequency threshold range (e.g., 1.5*delta_F˜3.5*delta_F). The set of transition RSCPs may include one or more RSCPs between the predefined RSCP threshold range (e.g., −70 dBm˜−90 dBm). The set of transition CIR_{SNR}s may include one or more CIR_{SNR}s between the predefined CIR_{SNR} threshold range (e.g., 3 dB˜10 dB).

Similar to switching from the good classification state 406 to the transition classification state 404, to switch from the bad classification state 408 to the transition classification state 404, the second transition condition (condition_transition_2) is satisfied.

A measurement schedule of the UE may be adjusted for the different classification states to improve communication. The measurement schedule may be adjusted to save UE battery power. In the best classification state 402, for example, the UE operates according to a reduced measurement schedule. In the good/transition classification state 406/404 the UE operates according to a normal measurement scheduled defined by a communications specification, for example. In the bad classification state 408, the UE operates according to an increased measurement schedule to expedite handover to an improved target cell.

For example, Table 3 illustrates the measurement period of various measurements of different radio access technologies relative to the classification states. The measurements may include inter frequency measurements (inter-F (e.g., serving and neighbor cells are TD-SCDMA)), inter radio access technology (IRAT) measurements for GSM neighbor cells, IRAT searches and measurements for low priority LTE neighbor cells and high priority LTE neighbor cells. When the UE is in the transition/good classification state, the scheduled inter-frequency measurement period may correspond to a normal inter-frequency measurement period defined by the communication specification (e.g. 2*P_InterF). In the best classification state, however, the inter-frequency measurement period may be longer than the normal inter-frequency measurement period. For example, the inter-frequency measurement period for the best classification state may be twice the normal inter-frequency measurement period (e.g. 4*P_InterF). In the bad classification, the inter-frequency measurement period is half the normal inter-frequency measurement period (i.e., P_InterF).

When the UE is in the transition/good/bad classification state, the scheduled IRAT measurement period for GSM neighbor cells for TD-SCDMA to GSM (T2G) handover/reselection may be the same (e.g., P_T2G). In the best classification state, however, the IRAT measurement period may be longer than the measurement period for GSM neighbor cells for TD-SCDMA to GSM (T2G) handover/reselection. For example, the IRAT measurement period for the best classification state may be twice P_T2G (i.e., 2*P_T2G). The search and/or measurement periods for the low priority LTE neighbor cells and high priority LTE neighbor cells, however, may be similar for the different classification states.

TABLE 3

| | | | IRAT LTE High | | IRAT LTE Low | |
|---|---|---|---|---|---|---|
| | Interfrequency | | Priority | | Priority | |
| | measurement | IRAT | Total | | Total | |
| | period | measurement | Search | | Search | |
| | (TD-SCDMA) | (GSM) | Time | Measure | Time | Measure |
| Best | 4*P_InterF | 2*P_T2G | 60 s | P_T2L | 30 s | P_T2L |
| Classification State | | | | | | |
| Transition/Good | 2*P_InterF | P_T2G | 60 s | P_T2L | 30 s | P_T2L |
| Classification State | | | | | | |
| Bad | P_InterF | P_T2G | 60 s | P_T2L | 30 s | P_T2L |
| Classification State | | | | | | |

Under the different classification states, the modem may control the power consumption of the UE to improve the power consumption of the UE. One aspect of controlling the power consumption of the UE involves controlling the power consumed for a handover or cell reselection procedure. During the handover or reselection procedure, the UE may be specified to perform activities related to one or more neighbor cells. For example, the UE may search or measure neighbor cells for signal quality, frequency channel, and base station identification. Such measurements or searches may be referred to as inter radio access technology (IRAT), inter-frequency, and intra-frequency measurements or searches.

The UE may adjust the performance of the handover/reselection or the activities to reduce the power consumption during the different classification states. In one aspect of the disclosure, a received signal code power and/or timer for triggering the handover or reselection are adjusted to reduce the power consumption by the UE. For example, a threshold received signal code power of a serving cell may be reduced when the UE is in the best classification state 402. However, the threshold received signal code power of a neighbor cell may be increased when the UE is in the best classification state 402. Similarly, the timer may be adjusted to delay or skip reselection/handover when the UE is in the best classification state 402.

The frequency of the search and/or measurement may be adjusted to reduce the power consumption during one or more of the classification states. For, example, adjusting the frequency of the search and/or measurement when the UE is in the best classification state 402 involves skipping the neighbor search and/or measurement. The UE skips the search and/or measurement based on the mobility information and the channel conditions, for example as illustrated in Table 1.

In another aspect of the disclosure, communications by the UE may be controlled based on the motion sensor device and channel conditions experienced by the UE when a determined level of mobility of the UE is below a first threshold. For example, controlling the communications may include adjusting the frequency of the search and/or measurement when the UE is in the good classification state 406. Controlling the communications may also include adjusting a periodicity of the neighbor search and/or measurement. That is, the search and/or measurement may be performed less frequently, as illustrated in Table 3.

In yet another aspect of the disclosure, the UE may also control the communications by preventing cell reselection or handover. The UE also controls communications by stopping neighbor search, neighbor measurement, cell reselection and/or handover when the motion sensor device and the level of mobility indicates the UE is stationary and the channel conditions are above a second threshold.

For example, the power consumption is improved when the UE is in the best classification state 402 by preventing cell reselection/handover based on the mobility information and the channel conditions. In the good classification state 406, however, the power consumption may be reduced by increasing a threshold for the reselection/handover. For example, if a serving cell quality is good enough (e.g., meets a threshold value) and the UE is in a static or low mobility state (e.g., best or transition classification state), handover may be delayed even when the handover conditions are met. However, if the serving cell quality is bad (e.g., less than the threshold) or the level of mobility of the UE is high (e.g., above a mobility threshold), handover may be expedited even when the handover conditions are not met. In some aspects, handover may be expedited when the UE is in the bad classification state and delayed when the UE is in the best classification state. The handover may be normal when the UE is in the good classification state.

In the bad classification state 408, the UE performs the activities based on an original modem algorithm. The modem device, however, may disable the motion sensor device during the bad classification state 408 to save power. For example, the modem device may disable the motion sensor device when the determined level of mobility of the UE is above the threshold. Further, the modem device disables the motion sensor device when the received signal code power-degrading degree is greater than or equal to the third predefined percentage. It is noted that in each of the examples above, monitoring for paging as well as decoding received pages is not skipped.

According to other aspects of the disclosure, controlling the communications includes increasing use of the motion sensor device when the level of mobility of the UE is low. The communications may also be controlled by decreasing motion detection by the motion sensor device when the level of mobility of the UE is high. Controlling communications further involves controlling power consumption. For example, controlling the power consumption includes increasing motion detection by the motion sensor device when the level of mobility is low and decreasing motion detection when the level of mobility is high. The motion detection may be increased by enabling the motion sensor device more often, e.g., every second. This increase may occur when the mobility state might change from stationary to moving. The motion detection may be decreased by disabling the motion sensor device or detecting mobility less frequently (e.g., sampling every 4-5 seconds.) The decrease may occur when moving from a mobility state to a stationary state.

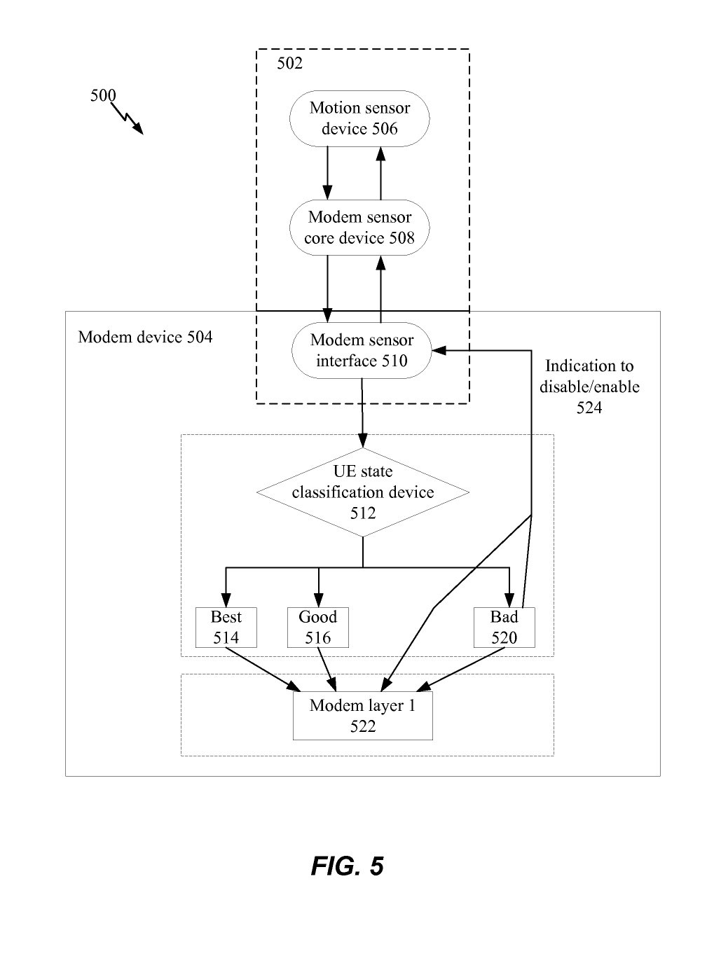

FIG. 5 illustrates a mobility and channel condition based power conservation implementation according to aspects of the disclosure. The implementation improves power consumption by a UE 500 based on channel conditions and detection of motion of the UE 500. The UE 500 may include a low power architecture 502 and a modem device 504. The low power architecture 502 may include a motion sensor device 506, a modem sensor core device 508, and a modem sensor interface 510 (e.g., an application programming interface). In one aspect of the disclosure, the low power architecture 502 is integrated into the modem device 504. In other aspects of the disclosure, the low power architecture 502 is partially integrated into the modem device 504 or is independent but coupled to the modem device 504. For example, the motion sensor device 506 and/or the modem sensor core device 508 may be independent but coupled to the modem device 504 via the modem sensor interface 510. The motion sensor device 506 senses motion and forwards sensor samples to the modem sensor core device 508, which can forward the information to the modem sensor interface 510.

The modem device 504 includes a UE state classification device 512 and a modem layer 1 522. The UE state classification device 512 is coupled to the low power architecture 502 and the modem layer 1 (physical layer) 522. In some aspects, the modem device 504 and the low power architecture 502 share a common memory.

In some aspects, the modem device 504 and sensors 506, 508 operate independently. That is, they wake up and go to sleep independently from one another. In other aspects, the modem device 504 and sensors 506, 508 operate in a synchronous mode. That is, they all wake at the same time, saving some power because some components (e.g., a DSP) are shared. Improved power savings can result from unified operation with both components operating on the same chip.

In one aspect of the disclosure, the motion of the UE 500 may be detected by the motion sensor device 506. The motion sensor device 506 generates an indication corresponding to the mobility state of the UE 500. For example, the motion sensor device indication may show that the UE 500 is in a stationary state or mobile state. The indication may also show that the UE 500 has transitioned from a first mobile state to another. For example, the indication may show that the UE 500 has transitioned from a mobile state to a stationary state or that the UE 500 has transitioned from a high mobility state to a low mobility state. The motion sensor device indication is forwarded to the UE state classification device 512 via the modem sensor interface 510 and/or the modem sensor core device 508.

The modem sensor core device 508 may estimate or determine the speed of the UE. For example, the modem sensor core device 508 may determine when the UE is in low speed or high speed based on Doppler estimation. Similar to the motion sensor device 506, the modem sensor core device 508 generates an indication corresponding to the speed of the UE. The indication from the modem sensor core device 508 is also forwarded to the UE state classification device 512 via the modem sensor interface 510 for further processing.

The UE state classification device 512 controls the power consumption of the UE based on the level of mobility of the UE, the mobility state of the UE and/or channel conditions. That is, the UE state classification device 512 integrates the indication from the motion sensor device 506, the indication from the modem sensor core device 508, and the modem channel conditions to control the power consumption of the UE.

Communication between the modem device 504 and the low power architecture 502 is bi-directional. For example, the modem device 504 receives indications corresponding to the level of mobility and the mobility state of the UE 500. The low power architecture 502 receives information from the modem device 504. The information received by the low power architecture 502 includes modem information (e.g., modem configuration information) and indications to enable or disable the motion sensor device 506 and/or the modem sensor core device 508. For example, when the UE 500 is in the bad classification state, the modem device 504 may send an indication 524 to disable the motion sensor device 506. The bidirectional communication is achieved through the modem sensor interface 510.

To control the power consumption of the UE 500, the UE state classification device 512 may classify the state of the UE 500 into different classification states based on the channel conditions, the level of mobility, and the mobility state of the UE. For example, the UE may be classified into different categories including “best 514,” “good 516,” and “bad 520” as previously discussed with respect to Table 1. Based on the different classification states, the modem device 504 may implement a low power procedure to apply different strategies for search and/or measurement of neighbor cells and for handover or reselection. For example, the different strategies may be applied at the modem layer 1 522 to either skip or adjust the frequency of the search and/or measurement or to skip reselection or handover. The low power procedure may be based on a process implemented at the UE state classification device 512 and/or the modem layer 1 522.

Aspects of the present disclosure improve a radio access technology (e.g., TD-SCDMA) standby power savings with reduced performance loss. For example, the mobility and channel condition based power conservation implementation reduces power consumption by skipping or reducing measurement and search of neighbor cells when the UE is in a stable environment with stable or ideal channel conditions. Power consumption is also reduced by skipping handover or reselection when the UE is in the stable environment with stable or ideal channel conditions. In addition, the mobility and channel condition based power conservation implementation also reduces or avoids the ping-pong effect.

Aspects of the present disclosure are directed to different radio access technologies such as global system for mobile communications (GSM), long term evolution, 1× radio transmission technology (1×), global navigation satellite system (GNSS), evolution data optimized (EV-DO) or any other cellular technology, wideband code division multiple access (WCDMA), and time division-synchronous code division multiple access (TD-SCDMA) and other radio access technologies.

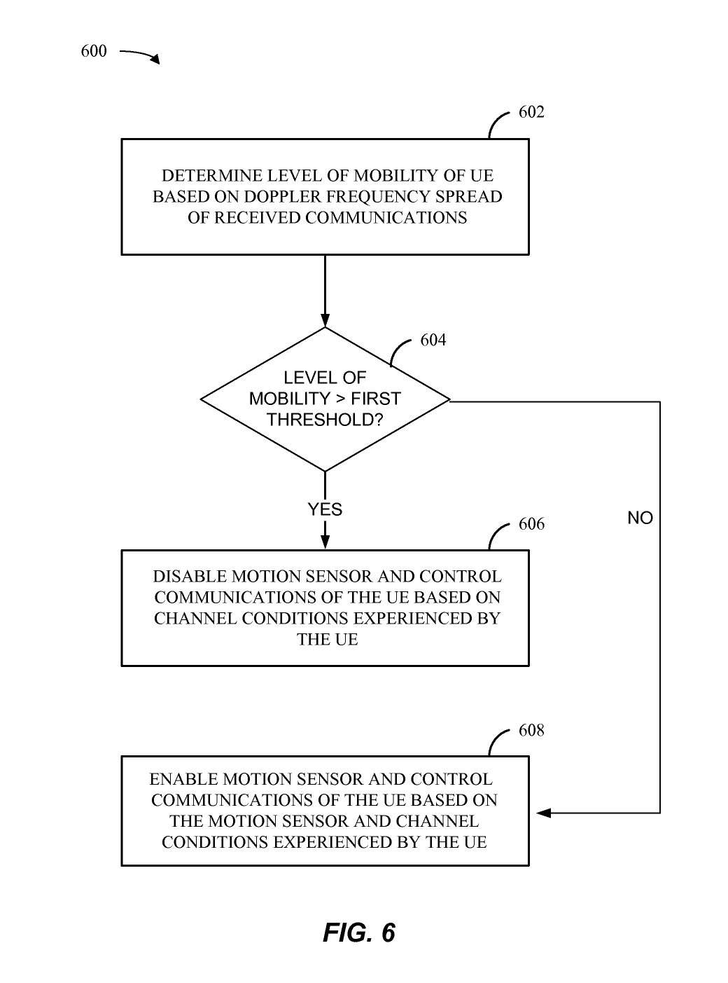

FIG. 6 shows a wireless communication method 600 according to one aspect of the disclosure. A user equipment (UE) determines a level of mobility of a UE based on a Doppler frequency spread of received communications, as shown in block 602. The UE determines whether a level of mobility of the UE meets a first threshold (e.g., exceeds the first threshold), as shown in block 604. The UE disables a motion sensor when the level of mobility meets the first threshold and controls communications of the UE based on channel conditions experienced by the UE, as shown in block 606. The UE enables a motion sensor when the level of mobility fails to meet the first threshold (e.g., below the first threshold) and controls communications of the UE based on the motion sensor and channel conditions experienced by the UE, as shown in block 608.

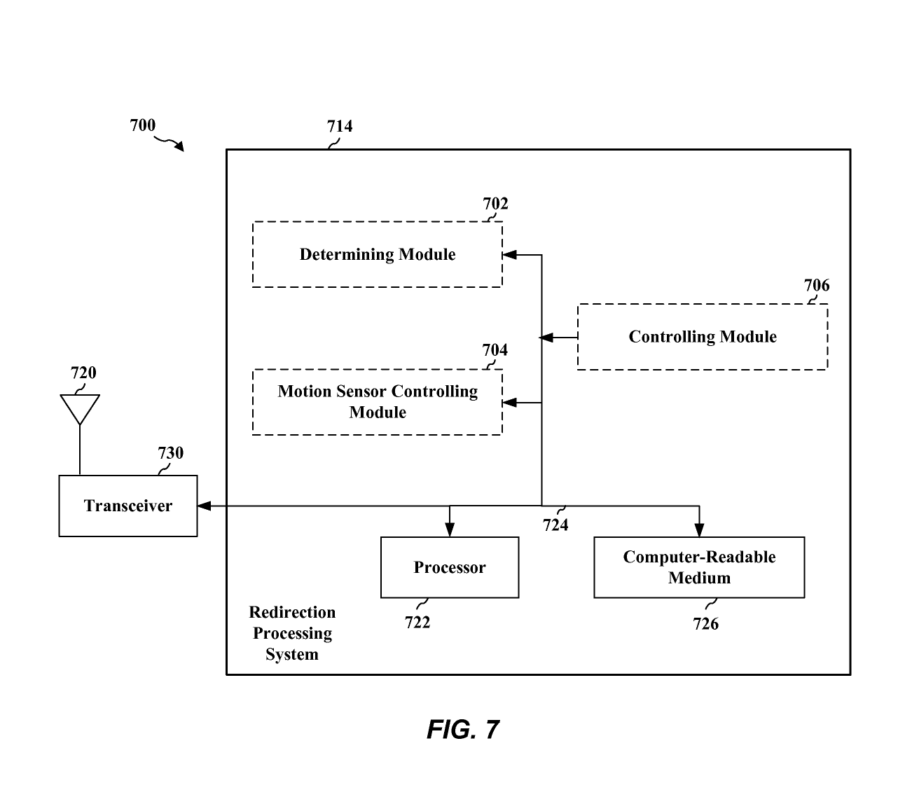

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatuses over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a determining module 702 for determining a level of mobility of a user equipment (UE) based on a Doppler frequency spread of received communications. The processing system 714 also includes a motion sensor controlling module 704 for disabling a motion sensor when the level of mobility is above a first threshold. The processing system 714 also includes a controlling module 706 for controlling communications of the UE based on the motion sensor and channel conditions experienced by the UE when the level of mobility is below the threshold. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for determining. In one aspect, the determining means may be the antennas 352/720, the receiver 354, the transceiver 730, the channel processor 394, the receive frame processor 360, the receive processor 370, the controller/processor 390, the memory 392, the power control module 391, the determining module 702, and/or the processing system 714 configured to perform the aforementioned means. In one configuration, the means functions correspond to the aforementioned structures. In another aspect, the aforementioned means may be any module or any apparatus configured to perform the functions recited by the aforementioned means.

The UE is also configured to include means for disabling. In one aspect, the disabling means may be the channel processor 394, the receive frame processor 360, the receive processor 370, the controller/processor 390, the memory 392, the power control module 391, the motion sensor controlling module 704, and/or the processing system 714 configured to perform the aforementioned means. In one configuration, the means functions correspond to the aforementioned structures. In another aspect, the aforementioned means may be any module or any apparatus configured to perform the functions recited by the aforementioned means.

The UE is also configured to include means for controlling. In one aspect, the controlling means may be the channel processor 394, the receive frame processor 360, the receive processor 370, the controller/processor 390, the memory 392, the power control module 391, the controlling module 706, and/or the processing system 714 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to LTE, TD-SCDMA, WCDMA, 1× radio transmission technology (1×), global navigation satellite system (GNSS), Evolution-Data Optimized (EV-DO), and GSM systems. As those skilled in the art will readily appreciate, various aspects described throughout this disclosure may be extended to other telecommunication systems, network architectures, and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+), and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric, such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of controlling power consumption of a user equipment (UE), comprising:
determining a level of mobility of a user equipment (UE) based at least in part on a Doppler frequency spread of received communications;
disabling a motion sensor when the level of mobility is above a first threshold; and
controlling communications of the UE based at least in part on the motion sensor and channel conditions experienced by the UE when the level of mobility is below the first threshold.

2. The method of claim 1, further comprising controlling communications of the UE based only on the channel conditions experienced by the UE when the level of mobility is above the first threshold.

3. The method of claim 1, in which controlling communications comprises altering a periodicity of one of a neighbor search and neighbor measurement.

4. The method of claim 1, in which controlling communications comprises preventing one of cell reselection and handover.

5. The method of claim 1, in which controlling communications comprises stopping one of neighbor search, neighbor measurement, cell reselection and handover when the motion sensor and the level of mobility indicates the UE is stationary and the channel conditions are above a second threshold.

6. The method of claim 1, in which controlling communications comprises increasing use of the motion sensor when the level of mobility of the UE is low, and decreasing motion detection by the motion sensor when the level of mobility of the UE is high.

7. An apparatus for controlling power consumption of a user equipment (UE), comprising:
means for determining a level of mobility of a user equipment (UE) based at least in part on a Doppler frequency spread of received communications;
means for disabling a motion sensor when the level of mobility is above a first threshold; and
means for controlling communications of the UE based at least in part on the motion sensor and channel conditions experienced by the UE when the level of mobility is below the first threshold.

8. The apparatus of claim 7, further comprising means for controlling communications of the UE based only on the channel conditions experienced by the UE when the level of mobility is above the first threshold.

9. The apparatus of claim 7, in which the communications controlling means further comprises means for altering a periodicity of one of a neighbor search and neighbor measurement.

10. The apparatus of claim 7, in which the communications controlling means further comprises means for preventing one of cell reselection and handover.

11. The apparatus of claim 7, in which the communications controlling means further comprises means for stopping one of neighbor search, neighbor measurement, cell reselection and handover when the motion sensor and the level of mobility indicates the UE is stationary and the channel conditions are above a second threshold.

12. The apparatus of claim 7, in which the communications controlling means further comprises means for increasing use of the motion sensor when the level of mobility of the UE is low, and means for decreasing motion detection by the motion sensor when the level of mobility of the UE is high.

13. An apparatus for controlling power consumption of a user equipment (UE), comprising:
a memory; and
at least one processor coupled to the memory and configured:
to determine a level of mobility of a user equipment (UE) based at least in part on a Doppler frequency spread of received communications;
to disable a motion sensor when the level of mobility is above a first threshold; and
to control communications of the UE based at least in part on the motion sensor and channel conditions experienced by the UE when the level of mobility is below the first threshold.

14. The apparatus of claim 13, in which the at least one processor is further configured to control communications of the UE based only on the channel conditions experienced by the UE when the level of mobility is above the first threshold.

15. The apparatus of claim 13, in which the at least one processor is further configured to control communications by altering a periodicity of one of a neighbor search and neighbor measurement.

16. The apparatus of claim 13, in which the at least one processor is further configured to control communications by preventing one of cell reselection and handover.

17. The apparatus of claim 13, in which the at least one processor is further configured to control communications by stopping one of neighbor search, neighbor measurement, cell reselection and handover when the motion sensor and the level of mobility indicates the UE is stationary and the channel conditions are above a second threshold.

18. The apparatus of claim 13, in which the at least one processor is further configured to control communications by increasing use of the motion sensor when the level of mobility of the UE is low, and by decreasing motion detection by the motion sensor when the level of mobility of the UE is high.

19. A non-transitory computer-readable medium having program code recorded thereon, the program code comprising:
program code to determine a level of mobility of a user equipment (UE) based at least in part on a Doppler frequency spread of received communications;
program code to disable a motion sensor when the level of mobility is above a first threshold; and
program code to control communications of the UE based at least in part on the motion sensor and channel conditions experienced by the UE when the level of mobility is below the first threshold.

20. The non-transitory computer-readable medium of claim 19, further comprising program code to control communications of the UE based only on the channel conditions experienced by the UE when the level of mobility is above the first threshold.

21. The non-transitory computer-readable medium of claim 19, in which the program code to control communications further comprises program code to alter a periodicity of one of a neighbor search and neighbor measurement.

22. The non-transitory computer-readable medium of claim 19, in which the program code to control communications further comprises program code to prevent one of cell reselection and handover.

23. The non-transitory computer-readable medium of claim 19, in which the program code to control communications further comprises program code to stop one of neighbor search, neighbor measurement, cell reselection and handover when the motion sensor and the level of mobility indicates the UE is stationary and the channel conditions are above a second threshold.

24. The non-transitory computer-readable medium of claim 19, in which the program code to control communications further comprises program code to increase use of the motion sensor when the level of mobility of the UE is low, and decrease motion detection by the motion sensor when the level of mobility of the UE is high.
